(19) United States
(12) Patent Application Publication
(10) Pub. No.: US 2005/0079393 A1
(43) Pub. Date: Apr. 14, 2005

(54) Method and system for controlling constant temperature for fuel cells

(76) Inventors: Hsi-Ming Shu, Taipei (TW); Feng-Yi Deng, Taipei (TW); Yean-Der Kuan, Taichung (TW); Jing-Tang Jan, Taipei (TW)

Correspondence Address: G. LINK CO., LTD, Suite 137, PMB 174, 931 West 75th Street, Naperville, IL, 60565, US

(21) Appl. No.: 10/952,759

(22) Filed: Sep. 30, 2004

(30) Foreign Application Priority Data
Oct. 14, 2003 (TW) 092128363

(51) Int. Cl. H01M 8/04; H01M 8/00; H01M 8/12; H01M 8/18

(52) U.S. Cl. 429/13; 429/22; 429/24; 429/20; 429/26

(57) ABSTRACT

This invention relates to a constant temperature control system for fuel cell systems. The first end of the heat pipe is extended into the interior of the temperature/fuel sensing layer in order to conduct the heat produced during the anode action of the fuel cell core component to the second end of the heat pipe. The second end of the heat pipe is connected to a heat sink. A device is used to disperse the heat and lower the temperature of the heat sink and a device to increase the temperature of the heat sink. A temperature control processing unit that detects the temperature and heat produced in the anode action of the fuel cell core component. As a result, the constant temperature control system keeps the temperature of the anode fuel within a predetermined temperature range, and increases the effectiveness of the anode action of the fuel cell core component.

### FIELD OF THE INVENTION

The present invention is related to a method and a system for controlling the temperature of a fuel cell system during its operations, particularly a method and a system of controlling and/or maintaining a constant temperature so that the anode fuel of a fuel cell system is controlled and/or maintained at a predetermined temperature range during the fuel cell system's operations.

### BACKGROUND OF THE INVENTION

The U.S. Pat. No. 6,146,779 entitled “Fluid flow plate, fuel cell assembly system, and method employing same for controlling heat in fuel cells” disclosed a method of using a heat pipe to control the heat of a fuel cell system. Although the U.S. Pat. No. 6,146,779 disclosed implementing a temperature control mechanism in fuel cell systems, it does not comprise a function for constant temperature control. Also, the flow plate and the fuel cell assembly system disclosed in the U. S. Pat. No. 6,146,779 are structurally complicated and difficult to manufacture. Further, due to the structural characteristics of the fluid flow plate of U.S. Pat. No. 6,146,779, the design of the temperature control system for the fuel cell assembly system is more suited for larger systems, but inappropriate for small and portable 3C electronic products or even smaller electronic devices.

The U. S. Pat. No. 6,598,397 entitled “Integrated micro combined heat and power system” disclosed the architecture of a heat pipe, a fuel cell system, and temperature control. However, U. S. Pat. No. 6,598,397 applies to generating electric power from heat dissipation wasted heat, unrelated to constant temperature control.

In view of the shortcomings of the above listed patents, the inventers of the present invention invented a method and a system for controlling a constant temperature. The method and the system can maintain the anode fuel within a predetermined temperature range during the fuel cell system's operations.

### SUMMARY OF THE INVENTION

The primary objective of the present invention is to provide a system and a method for maintaining a constant temperature in a fuel cell system, so that the fuel cell system maintains an environment of a predetermined temperature range during the anode's action, thereby achieving an effective power generation.

To achieve this objective, the present invention utilizes a constant temperature control system for the use of the fuel cell systems. The fuel cell system has one or more fuel cell core component and a temperature/fuel sensing layer coupled to the upper side of the anode of the fuel cell core component, providing flow space for the anode fuel during the anode action of the fuel cell core component. The constant temperature control system comprises one or more heat pipe at least partially placed on the temperature/fuel sensing layer. The first end of the heat pipe extends into the temperature/fuel sensing layer to conduct the heat produced during the anode action of the fuel cell core component to the other end of the heat pipe. The constant temperature control system also comprises a heat sink connected to the second end of the heat pipe, a heat-dispersing device to disperse the heat of the heat sink to lower the heat sink's temperature, a heating device to increase the temperature of the heat sink, and also a temperature control processing unit. Temperature control processing unit is used to detect the temperature and the heat generated during the anode action of the fuel cell core component, and to activate the heat-dispersing device to disperse the heat of the heat sink to lower the anode fuel's temperature if the anode fuel's temperature is higher than a predetermined temperature range. The temperature control processing unit is also used to activate the heating device to increases the temperature of the heat sink, thereby increasing the anode fuel's temperature, if the anode fuel's temperature falls lower than a predetermined temperature range. By using the constant temperature control system to keep the temperature of the anode fuel within a predetermined temperature range, the effectiveness of the fuel cell core component's anode action is increased.

Furthermore, to achieve the aforementioned objective, the present invention provides a method for controlling the constant temperature of the fuel cell systems, applicable to fuel cell systems with one or more fuel cell core component and at least one temperature/fuel sensing layer coupled onto the anode of the fuel cell core component. The temperature/fuel sensing layer provides flowing space for the anode fuel during the fuel cell core component's anode action. This method comprises the following: one or more heat pipe at least partially placed in the temperature/fuel sensing layer. The first end of the heat pipe is extended into the interior of the temperature/fuel sensing layer to conduct the heat produced in the fuel cell core component's anode action to the second end of the heat pipe; a heat sink, connected to the second end of the heat pipe; a heat dispersing device that disperses the heat of the heat sink to lower the temperature of the heat sink, and a heating device that heats the heat sink to increase the temperature of the heat sink. There is also a temperature control processing unit that detects the temperature of the heat produced in the anode action of the fuel cell core component, and activates the heat dispersing device to disperses the heat of the heat sink to lower anode fuel's the temperature if the anode fuel's temperature is higher than a predetermined temperature range. This unit further activates a heating device to increase the temperature of the heat sink and the temperature of anode fuel if the anode fuel's temperature is lower than a predetermined temperature range. By using the above steps to control the temperature of the anode fuel within a predetermined temperature range, the efficiency of the anode action of the fuel cell core computer should increase.

### BRIEF DESCRIPTION OF THE DRAWINGS

FIG. 1 is a structural diagram of the constant temperature control system for fuel cell systems according to the present invention;

FIG. 2 is a structural diagram of the fuel cell core component according to the present invention;

FIG. 3 is a structural diagram of the heat pipe placed in the temperature/fuel sensing layer according to the present invention;

FIG. 4 is a flow chart of the constant temperature control system for fuel cell systems according to the present invention; and

FIG. 5 is an illustrative view of the constant temperature control system for fuel cell systems being integrated with an electronic product according to the present invention.

### DETAILED DESCRIPTION OF THE INVENTION

The detailed description and technical characteristics of the present invention are described together with the drawings as follows.

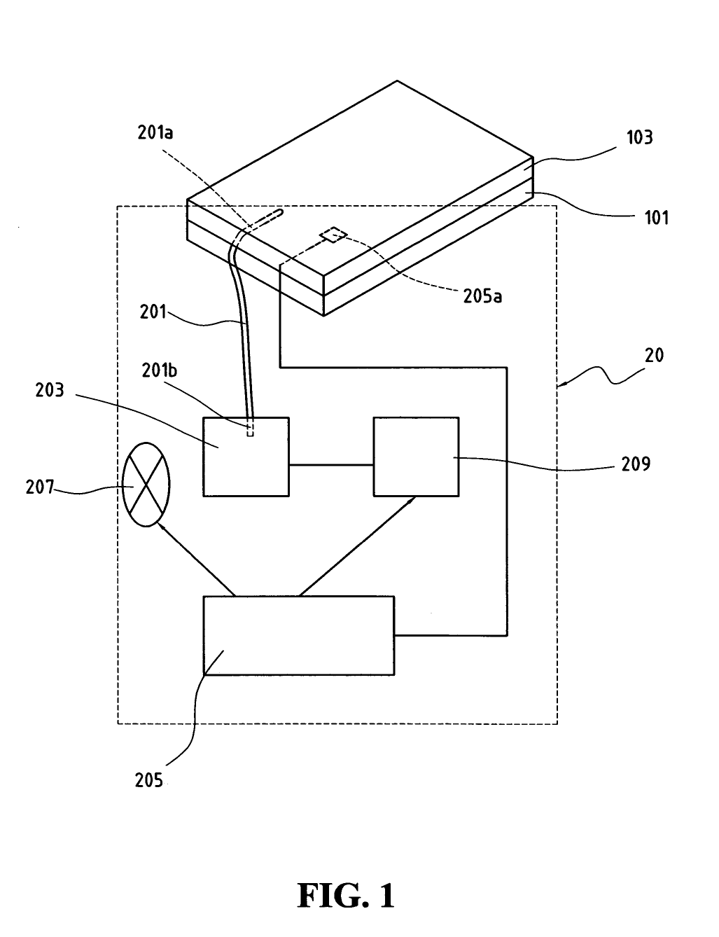

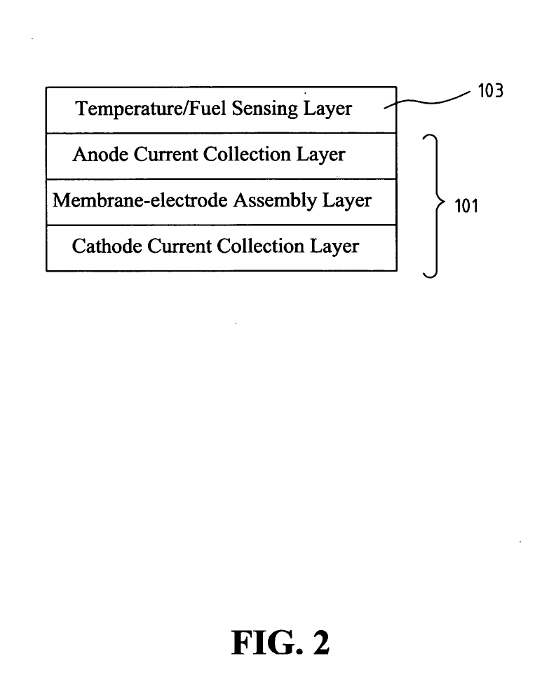

Please refer to FIG. 1 for the structural diagram of the constant temperature control system for fuel cell systems according to the present invention. The constant temperature control system 20 of the invention is applied in a fuel cell system 10. Because fuel cell core component 101 produces heat during chemical reaction, the amount of heat generated leads to considerably high temperature, especially if a plurality of the fuel cell core components 101 is connected in series or in parallel to jointly generate electricity. If such a temperature were not properly controlled, it would adversely affect the fuel cell system 10. Please refer to FIG. 2 for the structural diagram of the fuel cell core component of the present invention. The upper side of the anode of the fuel cell core component 101 is coupled to the temperature/fuel sensing layer 103. The main function of the temperature/fuel sensing layer 103 is to provide the anode fuel the flowing space necessary during the anode action of fuel cell core component 101. A part of the constant temperature control system 20 of the present invention is positioned on the temperature/fuel sensing layer 103, and the following passage discloses the constant temperature control system 20. The present invention uses a direct methanol fuel cell (DMFC) system as an example in order to illustrate how the constant temperature control system 20 can be used in a direct methanol fuel cell system. However, the present invention is not limited to the example of direct methanol fuel cell system with a constant temperature control system illustrate below. To the contrary, it is intended to cover various modifications and similar arrangements and procedures, and the scope of the appended claims therefore should be accorded the broadest interpretation so as to encompass all such modifications and similar arrangements and procedures.

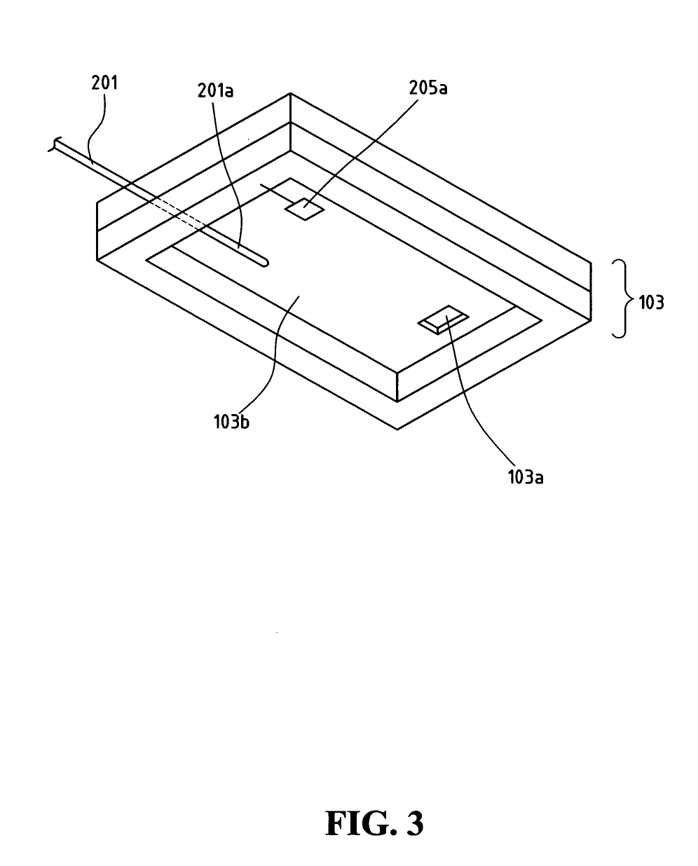

FIG. 3 shows the structural diagram of the heat pipe installed in the temperature/fuel sensing layer. The anode fuel can be injected into an anode fuel action area 103b through an injection hole 103a, and the fuel cell core component 101 carries out the anode action in the anode fuel action area 103b. Temperature/fuel sensing layer 103 may be formed by stacking two baseboard layers together. The lower baseboard may contain a hollow rectangular space inside to house the anode fuel action area 103b, and the upper baseboard may be a flat board with an injection hole 103a placed at the appropriate position. The present invention is comprised of at least one heat pipe 201, and a part of the heat pipe 201 is placed in the temperature/fuel sensing layer 103. The first end 201a of the heat pipe 201 is extended into the interior of the temperature/fuel sensing layer 103, where the heat pipe 201 conducts the heat produced in the anode action of the fuel cell core component 101 from the first end 201a of the heat pipe 201 to the second end 201b. In the embodiment, the first end 201a of the heat pipe 201 is coupled to the temperature/fuel sensing layer 103, and the first end 201a may be around 5 mm or larger, so that the first end 201a can be dipped in the methanol solution that acts as the anode fuel. The heat pipe 201 can use an adhesive agent with a heat insulating property to adhere to the temperature/fuel sensing layer 103. At the same time, the part of the heat pipe 210 extending into the interior of the temperature/fuel sensing layer 103 may be extended into the temperature/fuel sensing layer 103 by a method of drilling or digging groove(s) in the temperature/fuel sensing layer 103.

The second end 201b of the heat pipe 201 is coupled to the heat sink 203. The mean of coupling the second end 201b of the heat pipe 201 to the heat sink 203 may be by the mean of drilling a hole into the bottom of the heat sink 203 while making as much contact with the heat pipe 201 as possible. The gap produced while coupling may be sealed with a highly conductive heat paste to ensure that the heat pipe 201 and the heat sink 203 are attached closely together. The main purpose is to minimize the air gap between the heat pipe 201 and the heat sink 203. There can be one or more heat pipe(s) 201, the cross-sectional area of the heat pipe 201 may be circular or oval, and the heat pipe may be made of copper, yttrium barium copper oxide (YBCO), or any other material with high thermal conductivity coefficient. The wall of the heat pipe 201 may be made of sintering copper powders or any other metallic to be a porous material or screen mesh. The operating fluid inside the heat pipe 201 may be pure water or any other liquid with very low pressure inside which allows the phase changes occurs easily to increase the capability of transporting the heat. The heat will have a very high effective thermal conductivity coefficient k of over 5000 W/m-K (over 20000 or 50000 would have an even better effect).

The heat sink 203 connected to the second end 201b of the heat pipe 201 may be made of copper, aluminum, or any other material with a high thermal conductivity coefficient. The base of the heat sink 203 may be square, circular, or any other shapes. And the fins on the base may be parallel rectangular fins, vertically intersected fins, outwardly radial fins, or fins of any geometric shape with good heat exchange effect.

The main purpose of the heat-dispersing device 207 is to disperse the heat of the heat sink to lower the temperature of the heat sink 203. The heat-dispersing device 207 may be a fan or a blower, best if the rotary speed is adjustable for the purpose of changing the rate of wind flow and ensuring a good heat dispersion effect.

The main purpose of the heating device 209 is to heat and increase the temperature of the heat sink 203. The main purpose of the temperature control processing unit 205 is to detect the temperature of the heat produced by the fuel cell core component 101 during the anode action. At the same time, the temperature control processing unit 205 is used to activate the heat dispersing device 207 to disperse the heat of the heat sink 203 if the temperature of the anode fuel is above a predetermined temperature range. Since the heat dispersing device 207 expedites the temperature decrease of heat sink 203, this allows the anode fuel heat conducted by heat pipe 201 to be controlled to reduce its temperature. At the same time, the temperature control processing unit 205 can be used to activate the heating device 209 to increase the temperature of the heat sink 203 if the temperature of the anode fuel is lower than a predetermined temperature range. The heat produced is conducted from the second end 201b of the heat pipe 201 to the first end 201a, so the temperature of the anode fuel can be increased. In the embodiment, the temperature control processing unit 205 comprises at least one temperature sensor 205a placed in the temperature/fuel sensing layer 103, used to detect the current temperature of the anode fuel. The temperature sensor 205a may be or may include a heat sensitive resistor, a platinum resistor thermometer, an aluminum alloy thermocouple, an iron-copper-nickel alloy thermocouple, or a thermistor, etc. Further, the temperature control processing unit 205 may further comprises a processor that receives signals from the temperature sensor 205a, thereby obtains data on the current temperature data of the anode fuel, as well as activates/deactivate the heat dispersing device 207 and the heating device 209.

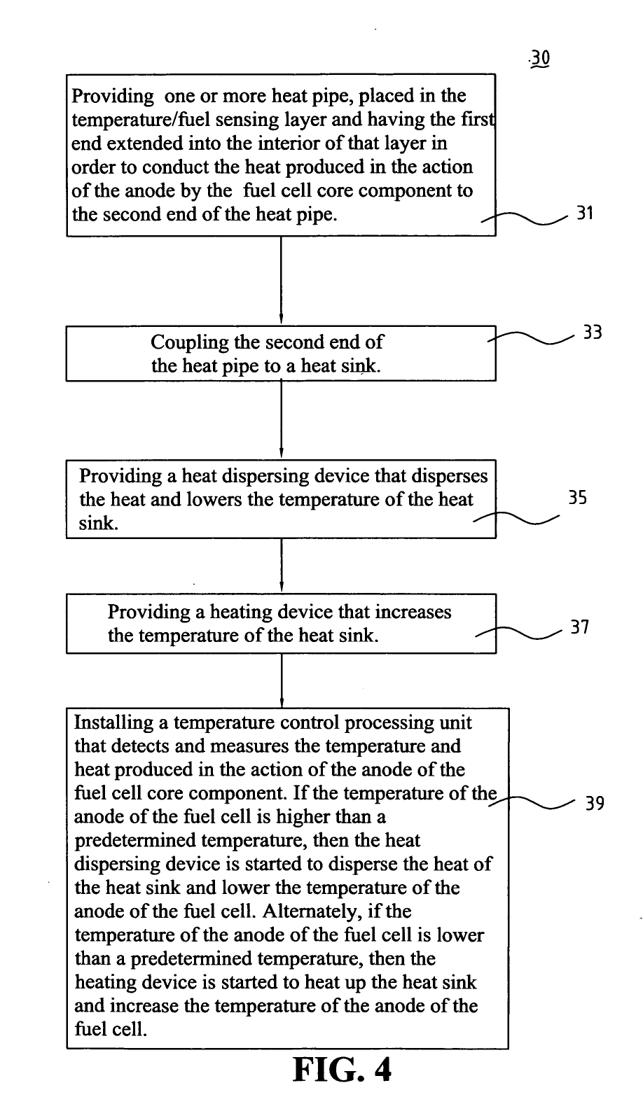

FIG. 4 shows the flow chart of the constant temperature control method for fuel cell systems according to the present invention. The constant temperature control method 30 of the present invention mainly comprises Step (31) to Step (39) as described below. Step (31) is to provide at least one heat pipe 201, and a part of the heat pipe 21 is placed in the temperature/fuel sensing layer 103. The first end 201a of the heat pipe 201 extends into the temperature/fuel sensing layer 103 where it conducts the heat produced in the anode action of the fuel cell core component 101 to the second end 201b of the heat pipe 201. Through heat pipe 201, the heat produced by the anode fuel at the temperature/fuel sensing layer 103 is conducted to the outside, or the heat outside may be brought into the anode fuel if temperature is higher on the outside. Step (33) is to connect the second end 201b of the heat pipe 201 with the heat sink 203. Step (35) shows the heat dispersing device 207 that disperses the heat produced by the heat sink 203 and lowers the temperature of the heat sink 203. Step (37) is to provide a heating device 209 for increasing the temperature of the heat sink 203. Step (39) is to install a temperature control processing unit 205 to detect the temperature of the heat produced in the anode action of the fuel cell core component 101. The unit 205 also activates the heat dispersing device 207 to disperse the heat of the heat sink 203 when the temperature of the anode fuel is higher than a predetermined temperature range, thereby decreases the temperature of the anode fuel. The unit 205 also activates the heating device 209 in order to increase the temperature of the heat sink 203 when the temperature of the anode fuel is lower than a predetermined temperature range, and thereby increases the temperature of the anode fuel. The constant temperature control method 30 of the present invention uses the aforementioned steps to keep the temperature of the anode fuel at a predetermined temperature range, thereby enhances the effectiveness of the anode action of the fuel cell core component 101. Using a DMFC system as an example, when a 5% methanol concentration is used as anode fuel, the preferred operation temperate of the DMFC system is 60° C. The constant temperature control method 30 of the present invention can control the methanol solution anode fuel disposed in the anode fuel action area 103b at this optimal operating temperature range of about/near 60° C.

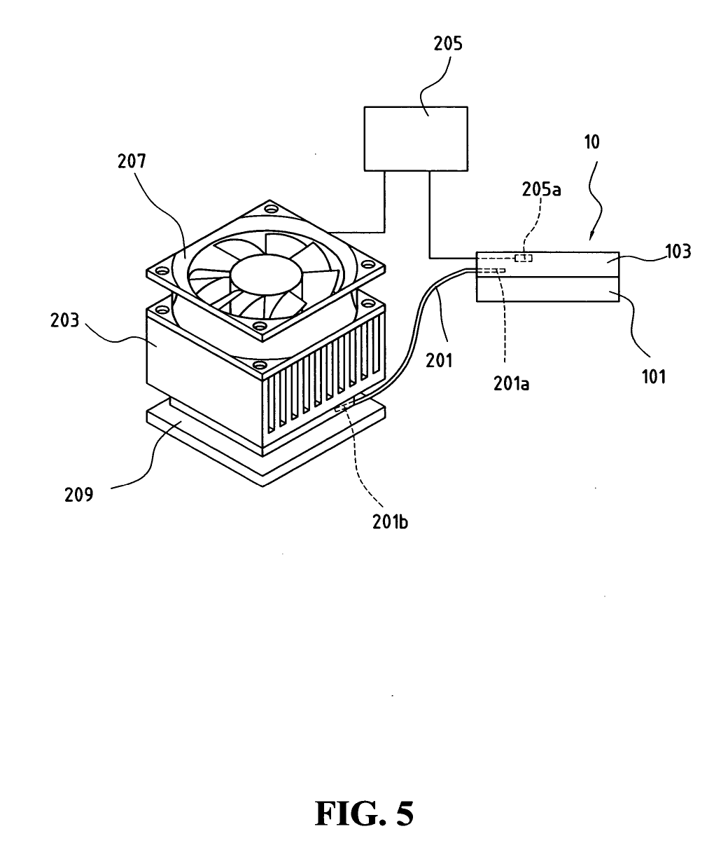

In this preferred embodiment of the present invention, the previously mentioned heat dispersing device 207, heating device 209 and heat sink 203 can be placed on the exterior of the fuel cell system 10. Because the first end 201a of the heat pipe 201 must be very close to the anode fuel, a part of the heat pipe 201 placed in the temperature/fuel sensing layer 103 must be coupled to the interior of the fuel cell system 10. Also because the temperature sensor 205a of the temperature control processing unit 205 must be close to the anode fuel, the temperature sensor 205a should be placed in the inside of the temperature/fuel sensing layer 103. FIG. 5 shows an illustrative diagram of the present invention integrated with an electronic device; the electronic device may be a notebook computer or any other mobile electronic device. In this integrated electronic product, the heat sink 203 may directly use the heat sink of the central processing unit (CPU), and the heat dispersing device 207 may use the fan on the heat sink of the CPU or another fan to jointly provide airflow to the heat sink. The heating device 209 could be a CPU or any other component in an electronic product, for example a chipset. The heat produced by a CPU or other component(s) during operations may be used to provide heat for use by the constant temperature control system 20.

In the preferred embodiment of the present invention, the heat pipe 201 is coupled to the temperature/fuel sensing layer 103 first, and then the temperature/fuel sensing layer 103 is coupled to the fuel cell core component 101 by means such as pressing, adhering, deposition, binding, fastening, clamping, or any other connecting method.

The present invention applies the heat pipe to fuel cell systems with a constant temperature control system, particularly to DMFC systems so that the DMFC system may operates in a stable environment. The present invention is definitely a pioneering effort. It offers advantages including: suitable for 3C electronic product or smaller electronic product; a heat pipe that can be manufactured or modified to different three-dimensional (3D) structure to cope with different spatial constraints/requirement, such as different appearance and shape of the fuel cell system and the design of the electronic device.

Although the invention has been described by way of example and in terms of a preferred embodiment, it is to be understood that the invention is not limited to these examples. To the contrary, it is intended to cover various modifications and similar arrangements and procedures, and the scope of the appended claims therefore should be accorded the broadest interpretation so as to encompass all such modifications and similar arrangements and procedures.

1. A constant temperature control system for fuel cell systems, wherein said fuel cell system comprises at least one fuel cell core component and a temperature/fuel sensing layer coupled to the top of an anode of said fuel cell core component, providing an anode fuel flowing space for an anode action of said fuel cell core component, said constant temperature control system comprises:
at least one heat pipe, wherein in a part of said heat pipe is placed at said temperature/fuel sensing layer and a first end of said heat pipe extends into the interior of said temperature/fuel sensing layer to conduct the heat produced in said anode action of said fuel cell core component to a second end of said heat pipe;
a heat sink, coupled to a second end of said heat pipe;
a heat dispersing device, for dispersing the heat of said heat sink to lower the temperature of said heat sink;
a heating device, for heating up said heat sink to increase the temperature of said heat sink; and
a temperature control processing unit, for the following functions: detecting the temperature of the heat produced in said anode action of said fuel cell core component; activating said heat dispersing device to disperse the heat of said heat sink when the temperature of said anode fuel is higher than a predetermined temperature range, thereby lower the temperature of said anode fuel; and activating said heating device to increase the temperature of said heat sink when the temperature of said anode fuel is lower than said predetermined temperature range, thereby increase the temperature of said anode fuel;
The said constant temperature control system keeps the temperature of said anode fuel within said predetermined temperature range, thereby increases the effectiveness of the said anode action of said fuel cell core component.

2. The constant temperature control system of claim 1, wherein said heat dispersing component is a fan or a blower.

3. The constant temperature control system of claim 1, wherein said heat sink is made of a material with a high thermal conductivity coefficient.

4. The constant temperature control system of claim 3, wherein said material is of copper or aluminum.

5. The constant temperature control system of claim 1, wherein said temperature control processing unit comprises at least one temperature sensor is disposed at said temperature/fuel sensing layer for detecting the temperature of said anode fuel.

6. The constant temperature control system of claim 1, wherein said fuel cell system is a direct methanol fuel cell system.

7. The constant temperature control system of claim 6, wherein said first end of said heat pipe dips in a direct methanol solution.

8. A method of controlling constant temperature of fuel cell systems, applicable to a fuel cell system with at least one fuel cell core component and a temperature/fuel sensing layer coupled to an upper side of an anode of said fuel cell core component for providing an anode fuel flowing space for an anode action of said fuel cell core component, said method comprises the steps of:
providing one or more heat pipe, and a part of said heat pipe is placed at said temperature/fuel sensing layer, and a first end of said heat pipe extends into the interior of said temperature/fuel sensing layer to conduct the heat produced in said anode action of said fuel cell core component to a second end of said heat pipe;
coupling a second end of said heat pipe to a heat sink;
providing a heat dispersing device, for dispersing the heat of said heat sink to lower the temperature of said heat sink;
providing a heating device, for heating up said heat sink to increase the temperature of said heat sink; and
installing a temperature control processing unit, for the following functions: detecting the temperature of heat produced in said anode action of said fuel cell core component; activating said heat dispersing device to disperse the heat of said heat sink when the temperature of said anode fuel is higher than a predetermined temperature range, thereby lowering the temperature of said anode fuel; and activating said heating device to increase the temperature of said heat sink when the temperature of said anode fuel is lower than said predetermined temperature range, thereby increasing the temperature of said anode fuel;
by means of the foregoing steps, said constant temperature control system maintains the temperature of said anode fuel within said predetermined temperature range, and enhances said anode action of said fuel cell core component.

9. The method of controlling constant temperature of fuel cell systems of claim 8, wherein said heat dispersing device is a fan or a blower.

10. The method of controlling constant temperature of fuel cell systems of claim 8, wherein said heat sink is made of a material with a high thermal conductivity coefficient.

11. The method of controlling constant temperature of fuel cell systems of claim 10, wherein said material is copper or aluminum.

12. The method of controlling constant temperature of fuel cell systems of claim 8, wherein said temperature control processing unit comprises at least one temperature sensor disposed at said temperature/fuel sensing layer for sensing the temperature of said anode fuel.

13. The method of controlling constant temperature of fuel cell systems of claim 8, wherein said fuel cell system is a direct methanol fuel cell system.

14. The method of controlling constant temperature of fuel cell systems of claim 13, wherein said first end of said heat pipe dips into a methanol solution.
